(19) United States
(12) Patent Application Publication
(10) Pub. No.: US 2018/0303686 A1
(43) Pub. Date: Oct. 25, 2018

(54) BED WITH MOVABLE FRAME

(71) Applicant: GERINET, S.L.U., Torrelavega (Cantabria) (ES)

(72) Inventor: Jose Luis Sanchez Vega, Torrelavega (Cantabria) (ES)

(21) Appl. No.: 15/515,316

(22) PCT Filed: Apr. 19, 2016
(86) PCT No.: PCT/ES2016/070272

§ 371 Date: Mar. 29, 2017

(30) Foreign Application Priority Data
Jan. 16, 2016 (ES) P201630041

(51) Int. Cl. A61G 7/005; A61G 7/018; A61G 7/05

(52) U.S. Cl. CPC A61G 7/005; A61G 7/0506; A61G 7/018

(57) ABSTRACT

A bed with movable frame; comprising a support base (1); —a movable headboard (3) and a movable footboard (2) with ability for vertical displacement and coupled to operational drive elements (32, 22); —a frame (4) provided with side rails (41) and end crosspieces (42); —a first mechanism (5) for attachment of the frame (4) to the movable footboard (2) with ability for displacement in the longitudinal direction; for rotation relative to a longitudinal axis X and rotation relative to a transverse axis Y; and —a second mechanism (6) for attachment of the frame (4) to the movable headboard (3) with ability for rotation relative to a longitudinal axis X′ and with ability for rotation relative to a transverse axis Y′.

### OBJECT OF THE INVENTION

The object of the invention is a bed with technical characteristics that give priority to the patient's position, as said position plays a very important role in their recovery and avoids complications that could arise during recovery/treatment.

The bed has a movable frame, which, can be dismantled in modules for access to homes, and it is of a safe design for people and animals.

The motors for lateral tilting-elevation are a potential injury hazard. For this reason, they are on the inside of the headboard-footboard. It presents characteristics intended to enable a manual or automated controlled movement of the frame, varying its tilting in the longitudinal direction and, at the same time, turning the entire surface of the frame avoiding pinching of the skin.

### STATE OF THE ART

Currently, various types of beds, especially for hospital use are known, which have a support base generally provided with wheels for rolling, and on which a headboard, a footboard, and a frame supporting a mattress base and mattress, are mounted.

Beds that allow tilting the frame in a longitudinal direction towards the headboard of the bed so that the user's feet are higher than the head, adopting the Trendelenburg position, are known; or tilting said frame longitudinally toward the footboard of the bed so that the head is higher than the user's feet adopting the position opposite to the previous one, that is, reverse Trendelenburg.

The Trendelenburg position is suitable for performing certain operations, for promoting postural drainage and venous return and for promoting cerebral blood flow; the name of the position being due to the German surgeon Friedrich Trendelenburg who started using said position.

Currently, various beds which allow positioning the patient in the Trendelenburg position and in the opposite (reverse Trendelenburg) position are known; however these beds have a very complex structure, with a high manufacturing cost and are impossible or difficult to transfer to a private home; a bed of this type is described in the U.S. Pat. No. 3,958,283.

Other beds, such as that described in the European patent EP 1 486 191, have a structure that could perform the necessary movements to achieve these positions but do not have a firm structure that allows the guaranteed movement of the patient, especially of adults or those above a certain weight. This risk of breakage will be even greater in the lateral movement because the patient's weight is supported by an edge of the bed structure.

There are also articulated beds which can be dismantled, as described in the U.S. Pat. No. 4,970,737 or beds that can be partially dismantled, as described in the U.S. Pat. No. 4,139,917, but which provide limited movement of the frame.

The closest document to the invention is the Chinese Patent CN 104161633, which is a bed provided with a fixed headboard and footboard on which is mounted a mattress base by means of short axes, which allow its rotation in the lateral direction when motors beneath the mattress base operate; it also has means for the elevation of one of the ends of the mattress base with respect to the corresponding fixed bed head.

With this constitution this bed can perform the tilting of the mattress base toward the footboard, the patient adopting the Trendelenburg position, or lateral tilting to facilitate the turning, lateral rotation, of the user.

However, this prior art has some ergonomic limitations since it cannot adopt a position opposite to the Trendelenburg position; and it has reduced strength for withstanding the lateral rotations.

The lateral tilting bed of the firm Linet, described in the patent CZ 20100707 A3, is an intensive care bed which has, under the mattress base, three telescopic columns attached to a wheeled base.

Other manufacturers, such as Hill-Rom, use beds with 4 columns.

Both models have drawbacks because they cannot access homes due to their volume and weight; they are not easily dismantled and do not have a safe design for a family environment, and have a very high manufacturing cost.

These beds perform a great diversity of lateral tilting movements, Trendelenburg positioning and elevation by the telescopic columns, which poses limitations of movement when programming the bed automatically.

Other lateral tilting beds as those described in the Chinese patent CN204016697 and the French patent FR2700949-A3 have a mattress base divided longitudinally into two mobile parts and one fixed central part. A drawback of these beds is that, when they are closed like a book, they provoke pinching of the user's skin causing the unwanted effect of pressure ulcers. These beds, which are complex and expensive to manufacture, cannot be dismantled nor are of suitable designs for a family environment.

These beds do not have elevation of the head and feet plane and the degrees of freedom of movement are limited; lateral movement is performed from the middle as in the known beds, which limits degrees of mobility, especially when the bed is tilted longitudinally and needs to be tilted laterally.

### DESCRIPTION OF THE INVENTION

The movable bed frame, object of this invention, has constructive particularities aimed at allowing easy mounting and dismantling thereof to facilitate transportation to the patient's home or installation point in either case.

The bed of the invention has a movable headboard and footboard, which are mounted on the support base with ability for vertical displacement and are coupled to operational drive elements so that the bed frame, arranged between the movable headboard and movable footboard can be tilted in the longitudinal direction, toward the headboard or toward the footboard by the elevation of the footboard or headboard respectively.

Furthermore, the bed has mechanisms for attaching the frame to the movable footboard and to the movable headboard that, besides tilting movements in the longitudinal direction in either direction, allow the lateral rotation of said frame by the operation of an actuator drivable by a manual or automatic control and that is in control of the rotation of the frame to one or the other side of the bed.

These mechanisms for attachment of the frame to the movable footboard and to the movable headboard define a longitudinal axis of lateral rotation of the entire frame relative to said headboard and footboard.

In the present description, the headboard and footboard are mentioned to facilitate understanding of the invention; however, it should be noted that the headboard could be taken as the footboard and vice versa, as this does not change the essence of the invention.

The drive elements responsible for vertically moving the headboard and footboard are independent of each other and also independent of the actuator responsible for controlling the lateral rotation of the frame. The mechanisms for attachment of the frame to the headboard and footboard allow that said frame can rotate laterally regardless of whether the frame is horizontal, or tilted longitudinally toward the headboard or toward the footboard.

Therefore, the headboard and footboard have full freedom of vertical movement, being said movements of the headboard independent, but compatible with the lateral tilting movements of the frame. This characteristic also allows overriding the lateral tilting movements when they are not recommended for medical reasons.

In this invention, the lateral tilting of the entire frame on the horizontal axis is made, unlike other beds, in which it is half of the frame that is moved to laterally position the patient with the risk of producing pinching of the patient.

One of the mechanisms connecting the frame to the headboard or the footboard, comprises a rod mounted telescopically on the corresponding end of the frame, which allows maintaining unchanged the determined distance between the footboard and the headboard when the tilting of the frame varies in the longitudinal direction, avoiding stresses in the frame structure in this displacement.

These and other characteristics of the invention will be better understood in view of the exemplary embodiment shown in the accompanying figures.

### DESCRIPTION OF THE FIGURES

In order to complement the description that is being carried out and with the purpose of facilitating the understanding of the characteristics of the invention, the present description is accompanied by a set of drawings wherein, by way of a non-limiting example, the following has been represented:

FIG. 1 shows an elevational view of an embodiment of the bed with movable frame according to the invention, in which the frame is shown in a horizontal position.

FIG. 2 shows a top plan view of the bed in FIG. 1.

FIG. 3 shows an elevational view of the first attachment device of the frame to the footboard of the bed.

FIG. 4 shows a plan view of the first attachment device of the frame to the footboard of the bed, partially sectioned.

FIG. 5 shows a front elevational view of a second frame mechanism for attachment of the frame to the movable headboard of the bed, said second mechanism being shown in a horizontal position, i.e., without lateral tilting.

FIG. 6 shows a view similar to the previous one, wherein the second mechanism for attachment of the frame to the headboard of the bed is shown tilted to one side.

FIGS. 7 and 8 show respective elevational views of the bed of FIG. 1 with the frame tilted in longitudinal direction, in opposite directions.

### PREFERRED EMBODIMENT OF THE INVENTION

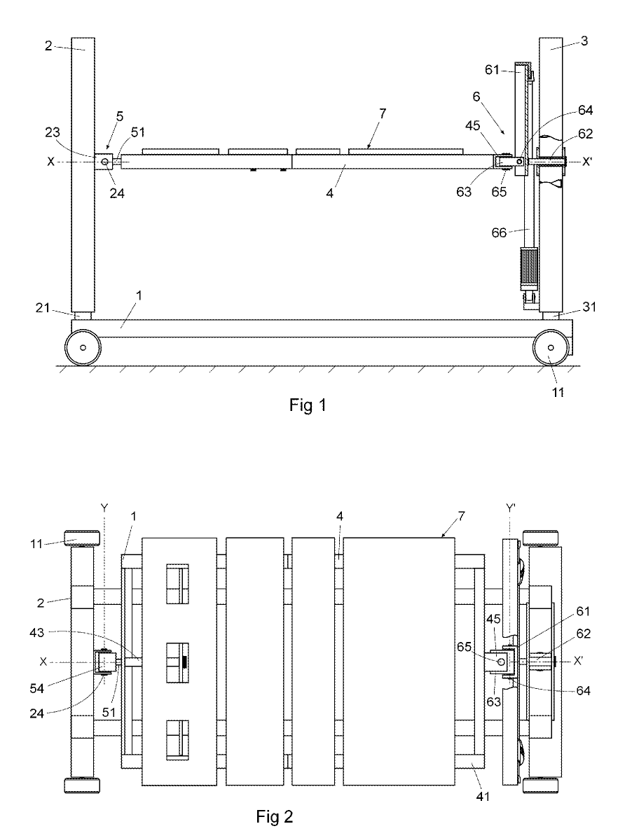

In the exemplary embodiment shown in FIG. 1, the bed with movable frame comprises a support base (1) provided with wheels (11), with a movable headboard (3) and a movable footboard (2) mounted on said base (1).

The movable headboard (3) and the movable footboard (2) are mounted with the ability for displacement along respective vertical columns (31, 21) attached to the support base (1). It should be noted that, in this exemplary embodiment, the headboard and footboard are shown mounted on respective pairs of vertical columns (21, 31), although the assembly of each one on a single vertical column is not excluded.

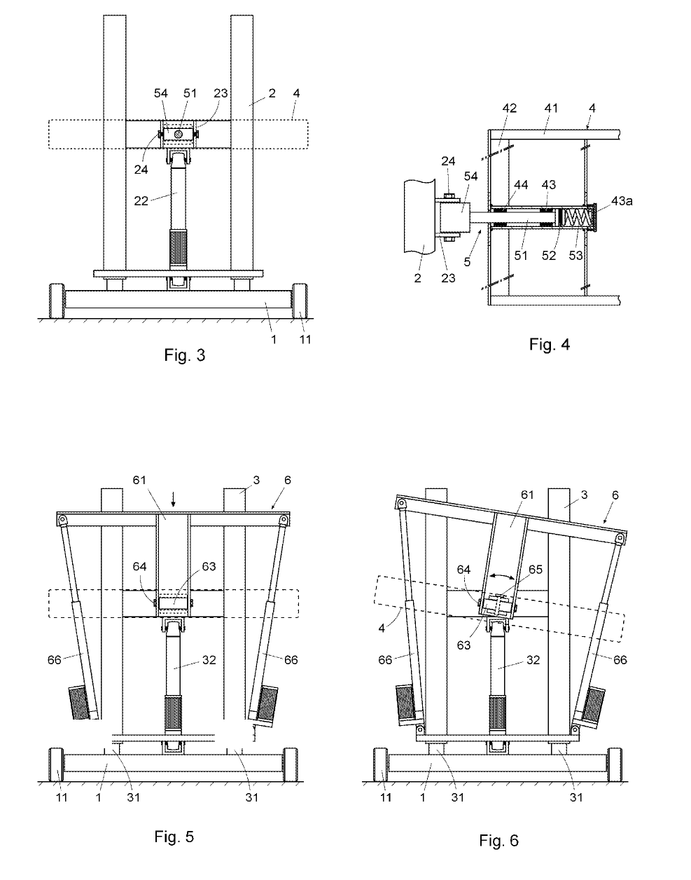

The footboard (2) and the headboard (3) are coupled to vertically operational drive elements (22, 32) operable independently by mechanical, electrical, pneumatic or hydraulic means, and specifically represented by electrical driving cylinders respectively visible in FIGS. 3 and 5.

The bed comprises a frame (4) provided with side rails (41) and end crosspieces (42) referred to in FIG. 4, said frame (4) being arranged between the movable headboard (3) and the movable footboard (2).

The bed comprises a first mechanism (5) for attachment of the frame (4) to the movable footboard (2) with ability for rotation relative to a longitudinal axis (X), referred to in FIG. 1, and for rotation relative to a transverse axis (Y), shown in FIG. 2.

This bed includes a second mechanism (6) for attachment of the frame (4) to the movable headboard (3), with ability for rotation relative to a longitudinal axis (X′), referred to in FIG. 1, and with the ability for rotation relative to a transversal axis (Y′), shown in FIG. 2.

The frame (4) constitutes the support for any type of mattress base (7) for the assembly of a mattress base on the frame (4), shown in the aforementioned FIGS. 1 and 2 a mattress base (7) provided with four planes of which three are intended to support the trunk and legs, and are movable, while the fourth is intended to support the area of the coccyx and is fixed.

In FIGS. 3 and 4 the first mechanism (5) for attachment of one of the ends of the frame (4) by its central area to the footboard (2) is shown.

In this exemplary embodiment the movable footboard (2) features an “H” type configuration, on which the vertically operational drive element (22) acts vertically.

The first mechanism (5) comprises a rod (51) mounted telescopically on the corresponding end of the frame (4), said rod (51) forming a longitudinal sliding guide and a longitudinal axis (X) of rotation of the frame (4) relative to the footboard (2).

The rod (51) is mounted telescopically on a tube (43) fixed solidly to the frame (4), and which contains in its interior a spring (53) that acts with its ends against a closing threaded cap (43a) of one end of the tube (43) and against a piston (52) defined in one of the ends of the rod (51). In the interior of the tube (43) anti-friction bushings (44) are arranged for the longitudinal displacement of the rod (51) caused by the tilting of the frame (4) in longitudinal direction.

This rod (51) has, on one end protruding from the frame (4), a head (54) arranged between lugs (23) of the movable footboard (2) and attached to the same by means of a bolt (24) forming the rotational transversal axis (Y) of the frame (4) relative to the footboard (2).

In FIGS. 2, 5, and 6 the second mechanism (6) for attachment of the frame (4) to the movable headboard (3) can be seen.

This second mechanism (6) includes a rotating part (61) provided with a rod (62) mounted with the ability for rotation relative to the movable headboard (3), said rod forming a rotational longitudinal axis (X′).

This second mechanism (6) comprises a block (63) facing the rotational rod (62) and fixed to the rotating part (61) by a pin (64) forming a rotational transversal axis (Y′) of the frame relative to the second mechanism (6) for attachment.

As can be more clearly seen in the FIGS. 1 and 2, the corresponding end of the frame (4) is attached to the aforementioned block (63) by a pin (65), which passes through lugs (45) defined in the central area of the corresponding end of the frame (4) and the aforementioned block (63).

This second mechanism (6) comprises at least one actuator mechanism (66), in this particular case two actuators mechanisms (66), shown in FIGS. 5 and 6, using respective electric drive cylinders, actionable simultaneously and in opposite directions, by a manual or automatic control, not shown; these actuators (66) performing a function of rotation control of the second mechanism (6) and, consequently, of the frame (4) relative to the longitudinal axis (X′).

The drive element (22), the drive element (32) and the actuator mechanism (66) are operable independently.

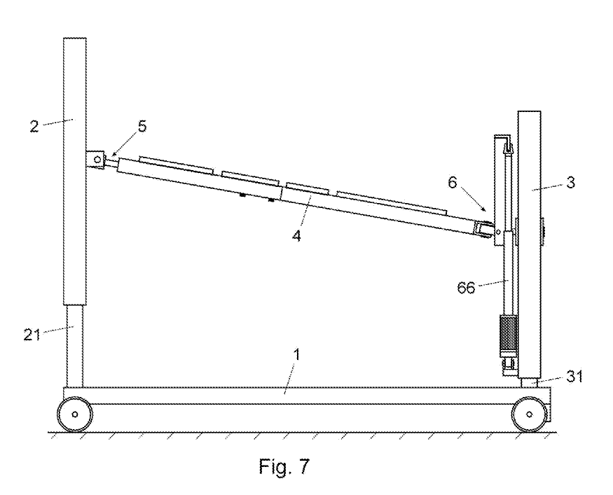

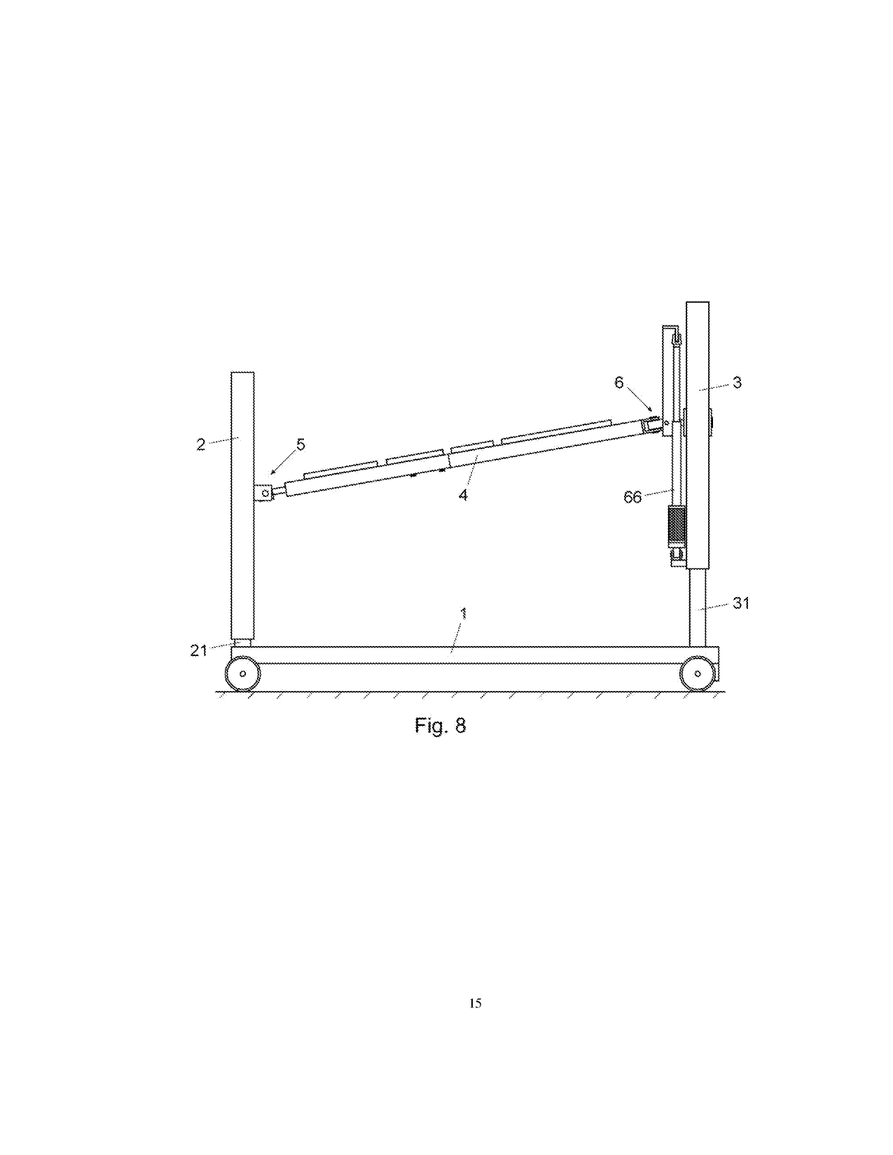

As can be seen in FIGS. 1, 7, and 8, by operating the drive elements (22, 32), responsible for vertically moving the headboard (3) and the footboard (2), they are able to be arranged at variable heights at which the frame is arranged in the horizontal position (FIG. 1), in a position tilting towards the footboard (FIG. 8) or in a position tilted towards the headboard (FIG. 7).

As can be seen in FIG. 1, in the horizontal position of the frame (4), the longitudinal axes (X, X′) of rotation are aligned in the longitudinal direction.

In addition to the tilting of the frame (4) in longitudinal direction towards the headboard or footboard, this bed allows, by means of the second mechanism (6), as shown in FIG. 6, the actuators (66) mounted on the movable headboard (3) to act on the side ends of the rotating part (61), causing its rotation relative to the longitudinal axis (X′) and consequently the tilting of the frame (4) towards one side or the other.

In one embodiment of the invention, the frame (4) is arranged at a height of about 500 millimetres from the floor, minimising possible injury of the user in the case of an accidental fall from the bed.

Finally, it should be noted that it is envisaged that both the headboard and footboard are panelled externally, to avoid potential interference of the patient or health workers with the motors and moving parts mounted thereon.

Once the nature of the invention as well as an example of preferred embodiment have been sufficiently described, it is stated for all pertinent purposes that the materials, form, size and arrangement of the elements described are susceptible to changes, provided these do not involve an alteration of the essential characteristics of the invention that are claimed subsequently.

1. A bed with movable frame; comprising a support base (1) on which a headboard, a footboard and a frame (4) to support a mattress base and mattress are mounted, characterised in that it comprises:
a movable headboard (3) mounted on the support base (1) with ability for vertical displacement and coupled to an operational drive element (32);
a movable footboard (2) mounted on the support base (1) with ability for vertical displacement and coupled to an operational drive element (22);
a frame (4) provided with side rails (41) and end crosspieces (42) arranged between the movable headboard (3) and the movable footboard (2);
a first mechanism (5) for attachment of the frame (4) to the movable footboard (2) with ability for displacement of the frame (4) in a longitudinal axis X direction, of rotation of the frame (4) relative to a longitudinal axis X; and of rotation of the frame (4) relative to a transverse axis Y;
a second mechanism (6) for attachment of the frame (4) to the movable headboard (3) with ability for rotation relative to a longitudinal axis X′ and ability for rotation relative to a transverse axis Y′, said second mechanism (6) comprising at least one actuator mechanism (66), operated by a manual or automatic control for controlling the rotation of the frame relative to the longitudinal axis X′; the drive element (22), the drive element (32) and the actuator mechanism (66) being operated independently.

2. The bed, according to claim 1, characterised in that the movable headboard (3) and the movable footboard (2) are mounted with ability for displacement along respective vertical columns (31, 21) fixed to the support base (1), and coupled to vertically operational drive elements (32, 22) operable independently by mechanical, electrical, pneumatic or hydraulic means, arranging the headboard and the footboard at a variable height at which the frame (4) is arranged in a horizontal position, in a position tilted towards the footboard, or in a position tilted towards the headboard.

3. The bed, according to claim 1, characterised in that the first mechanism for attachment comprises a rod (51) telescopically mounted on one of the ends of the frame (4), forming a longitudinal displacement guide and a longitudinal axis X of rotation of the frame (4) relative to the footboard (2); whose rod (51) has, at one end projecting from the frame, a head (54) fixed to the movable footboard (2) by a bolt (24) forming the transverse axis Y of rotation of the frame (4) relative to the footboard (2).

4. The bed, according to claim 1, characterised in that the second mechanism comprises: a rotating part (61) provided with a rod (62) associated with the movable headboard (3) forming the axis X′ of rotation, a block (63) facing said rod 62 and fixed to the rotating part (61) by a pin (64) forming the transverse axis Y′ of rotation, and at least one actuator mounted on the movable headboard acting on a side end of the rotating part (61) causing its rotation relative to the axis X′.

5. The bed according to claim 1; characterised in that, in the horizontal position of the frame (4), the axes X and X′ of rotation are aligned in the longitudinal direction.
